(19) United States
(12) Patent Application Publication
(10) Pub. No.: US 2016/0308999 A1
(43) Pub. Date: Oct. 20, 2016

(54) CAPTURING CANDIDATE PROFILES

(71) Applicant: Gild, Inc., San Francisco, CA (US)

(72) Inventors: Luca Bonmassar, San Francisco, CA (US); Francesco Laurita, San Francisco, CA (US); Stefano Fontanelli, San Francisco, CA (US); Guido Bellomo, Milano (IT)

(21) Appl. No.: 14/843,933

(22) Filed: Sep. 2, 2015

Related U.S. Application Data
(60) Provisional application No. 62/150,267, filed on Apr. 20, 2015.

(51) Int. Cl. H04L 29/08; H04L 12/58

(52) U.S. Cl. CPC H04L 67/327; H04L 51/32; H04L 67/02; H04L 67/306

(57) ABSTRACT

Some embodiments of the invention provide novel methods for capturing the profiles of employment candidates. To start the process for capturing such profiles, some embodiments provide a thin browser agent that can be executed within a browser when the browser is displaying an employment candidates profile on a social media webpage. After selection of the browser agent (e.g., a bookmarklet or a browser extension), the browser agent in some embodiments sends to a set of servers the URL (uniform resource locator) of the webpage that the browser is displaying when the agent is selected. The server set can include one server or more than one server. The server set determines whether the URL is part of a set of one or more social media communities from which the server set can capture employment candidate profiles. When the server set cannot identify a social media community for the webpage at issue, the server set in some embodiments returns to the browser agent a message to indicate that it cannot capture a profile from this page. On the other hand, when the server set matches the URL to a social media community, the server set in some embodiments informs the browser agent to send a copy of the webpage to the server set. In other embodiments, the server set does not immediately ask the browser agent to send a copy of the webpage after matching the URL to a social media community. For instance, even after the server set matches the URL to a social media community, the server set will not request the profile webpage until the user that is viewing the webpage requests the candidate profile to be captured.

### BACKGROUND

With the proliferation of social media websites, many online communities have been formed for enabling networking between professionals, and facilitating finding of suitable employment candidates. Today, many employee candidates are found through searches of candidate profiles that are listed on such social media websites. Accordingly, there is a need for a robust set of tools for quickly gathering candidate profiles online.

### SUMMARY

Some embodiments of the invention provide novel methods for capturing the profiles of employment candidates. To start the process for capturing such profiles, some embodiments provide a thin browser agent that can be executed within a browser when the browser is displaying an employment candidates profile on a social media webpage. In some embodiments, the browser agent is a bookmarklet (i.e., a bookmark with Javascript code) that can be selected while viewing a candidate's profile on a webpage. In other embodiments, the browser agent is a web browser extension that is installed as a browser plugin. Some embodiments allow a browser to include both a bookmarklet and a browser extension.

After selection of the browser agent (e.g., the bookmarklet or browser extension), the browser agent in some embodiments sends to a set of servers the URL (uniform resource locator) of the webpage that the browser is displaying when the agent is selected. The server set can include one server or more than one server. The server set determines whether the URL is part of a set of one or more social media communities from which the server set can capture employment candidate profiles. For instance, in some embodiments, the server set parses the URL to extract the portion of the URL that identifies the website domain, and then compares this extracted portion with known social media community domains to determine whether the webpage at issue is part of a known social media community.

When the server set cannot identify a social media community for the webpage at issue, the server set in some embodiments returns to the browser agent a message to indicate that it cannot capture a profile from this page. On the other hand, when the server set matches the URL to a social media community, the server set in some embodiments directs the browser agent to send a copy of the webpage to the server set. In other embodiments, the server set does not immediately ask the browser agent to send a copy of the webpage after matching the URL to a social media community. For instance, even after the server set matches the URL to a social media community, the server set will not request the profile webpage until the user that is viewing the webpage requests the candidate profile to be captured.

However, in some of these embodiments, the server set provides some data to the browser agent after matching the URL to a social community website. For example, in some embodiments, the server set might be able to match the provided URL not only to a social media community but also to a particular profile within that community (e.g., the URL might specify one or more candidate attributes that the server set uses to match the URL to a particular candidate) that the server set has previously captured. To help match the URL to previously captured profiles, the browser agent in some embodiments sends, with the URL, one or more data tuples that it parses from the webpage. In other embodiments, the browser agent does not parse and send any profile data tuples with the URL.

In some of these embodiments, the server set might provide profile data tuples from the previously captured profile to the browser agent after it matches the received URL to a previously captured candidate profile. The browser agent then displays the supplied profile data tuples. If the user then selects the option to capture the profile again at this point, the browser agent in these embodiments sends a copy of the webpage to the server set so that the server set can use this copy to try to refresh the previously captured profile.

Upon receiving the webpage, the server set in some embodiments parses the webpage into a plurality of profile data tuples that it then stores in a common profile data storage. In some embodiments, the server set can capture a candidate's profile from various different social media communities, reconcile the captured data and store the reconciled data in the profile date store. This allows the sever set to store a complete 360 degree view of a candidate, which can be accessed to view the candidate's profile by itself or as part of a search query of the data storage.

To store the profiles that are captured from various different social media communities in the common profile data storage, the server set uses different parsing and mapping processes for webpages from different communities because different communities typically store the profiles differently. Each community's process is defined based on the community's profile webpage template. As such, each community's process is defined to correctly parse each community's profile webpages and to correctly map the parsed data tuples to the uniform data structure of the common profile data storage.

As part of the process for capturing a displayed candidate profile, the browser agent of some embodiments allows the user to specify a particular folder or category of a candidate relationship management (CRM) system or applicant tracking system (ATS) that should be associated with the candidate profile. In some embodiments, the browser agent can allow the user to specify the folder/category before sending the URL to the server set, and/or after sending the URL to the server set (e.g., after being directed to send a copy of the webpage). Also, as part of the process for capturing the candidate profile, the browser agent of some embodiments allows the user to specify comments that should be associated with the candidate profile in the ATS or CRM system. In some embodiments, the browser agent also allows the user to send one or more messages about a captured candidate profile to one or more users of the ATS or CRM system.

In some embodiments, the server set might provide data and/or instructions that the browser agent needs to perform its operations before the browser agent is directed to capture a webpage. For instance, when the browser agent is a bookmarklet, the server set sends to the browser with the selected bookmarklet (1) additional Javascript code for browser to execute for the bookmarklet and/or (2) data for the browser to process to facilitate the selected bookmarklet operation. One example of such data includes data that (1) identifies folders/categories that can be associated to profiles, (2) identifies other ATS or CRM users that are related to the user that is viewing the candidate profile, and/or (3) identifies duplicate candidate profiles in the ATS or CRM system (e.g., in the embodiments where the server set matches the URL to a previously captured profile in the profile data storage). This data can be used to pre-populate menus or auto-populate menus as the user interacts with these menus to specify categories or send messages.

In some embodiments, the method uses the browser extensions to update candidate profiles. The method in some embodiments detects that a browser with a browser extension is currently executing on a remote computer. In some embodiments, this browser is the browser of a user that previously captured a set of candidate profiles and stored these profiles in the profile data storage of the method. This browser in some embodiments can also be the browser of any user that is part of a department, an organization, and/or entity for which the set of candidate profiles were collected.

After determining that a needed browser extension is available (as its browser is open), the method then requests that the browser extension retrieve copies of a set of one or more webpages that contains a set of one or more candidate profiles that were previously collected. In some embodiments, the set of webpages that the method provides to the browser extension include at least two webpages regarding the same candidate on two different social media communities. The method then uses any webpage that it receives in response to this request to try to update a set of previously collected profiles.

In its attempt to update previously collected profiles, the method of some embodiments extracts a plurality of data tuples from each webpage that it receives and compares each extracted data tuple with a corresponding data tuple in a previously collected profile to determine whether the extracted data tuple should replace the corresponding data tuple in the profile. In some embodiments, the determination of whether the extracted data tuple should replace the previously stored data tuple involves using a set of criteria to designate one of the two data tuples as a best version of truth. The set of criteria in some embodiments includes one or more of the following criteria: (1) a reputation value associated with each source of each data tuple, (2) a time value associated with when each data tuple was obtained, and (3) a relevancy value that quantifies the relevancy of the source of the data tuple with the data tuple's type. Other embodiments use other types of criteria to assess the best version of truth.

In some embodiments, the browser extension unobtrusively performs its webpage collection in the background so that it does not interfere with the browsing and other operations of the remote computer. To perform its operations unobtrusively in the background, the browser (1) assesses available computational resources of a device on which the browser executes, and (2) when a device has sufficient computational resources, initiates a background data gathering process that does not consume an amount of computation resources that would interfere with other operations currently being performed on the device.

To minimize the load, the method only periodically tries to refresh the collected candidate profiles in some embodiment. For instance, in some embodiments, the method determines whether a time has been reached to try to update a set of candidate profiles. If not, the method waits. Otherwise, when the time is reached, the method determines whether a browser with the needed browser extension is open on a remote computer. As mentioned above, this browser in some embodiments is a browser of the user that captured the set of candidate profiles, while in other embodiments this browser can be the browser of any user that is a member of the department, organization, or entity for which the set of candidate profiles were captured (e.g., the browser of a user in the same department, organization or entity as the user who captured the set of candidate profiles). In some embodiments, when more than one browser extension is available, the method uses the browser extension on the remote computer with the least load, or uses multiple browser extensions to distribute the load (e.g., for different candidate profiles that need to be updated) of the profile update process.

In still other embodiments, the method performs its profile update process only from the pool of available browser extensions. In other words, in these embodiments, the method first identifies the group of browser extensions that are currently available, and then determines whether for that browser extension group there are any associated candidate profiles that need to be updated at that time.

In some embodiments, the method maintains different refresh cycles for different social media communities. For communities that are updated more regularly by their users, the refresh cycles are shorter than the communities that are updated less regularly by their users.

The preceding Summary is intended to serve as a brief introduction to some embodiments of the invention. It is not meant to be an introduction or overview of all inventive subject matter disclosed in this document. The Detailed Description that follows and the Drawings that are referred to in the Detailed Description will further describe the embodiments described in the Summary as well as other embodiments. Accordingly, to understand all the embodiments described by this document, a full review of the Summary, Detailed Description, the Drawings and the Claims is needed. Moreover, the claimed subject matters are not to be limited by the illustrative details in the Summary, Detailed Description and the Drawing.

### BRIEF DESCRIPTION OF THE DRAWINGS

The novel features of the invention are set forth in the appended claims. However, for purposes of explanation, several embodiments of the invention are set forth in the following figures.

FIG. 1 illustrates a candidate management system (CMS) that uses the thin browser agent method of some embodiments to capture candidate profiles.

FIG. 2 illustrates a process that conceptually illustrates various operations that a browser agent and the CMS server set performs after a user performs an operation that the CMS server set interprets as the start of a profile capture process.

FIG. 3 illustrates an example that shows how the bookmarklet of some embodiments allows the user to specify a folder to which a candidate profile is added.

FIG. 4 illustrates the bookmarklet window that the browser shows after the selection of the CMS bookmarklet.

FIG. 5 shows a drop down window opening when the user types the handle of another CMS user in the comment field.

FIG. 6 shows the comments window populated with a comment.

FIGS. 7-8 illustrate examples of the browser extension user interface of some embodiments.

FIG. 9 illustrates an example of a webpage that the CMS webserver of some embodiments provide to present a candidate's profile.

FIG. 10 conceptually illustrates a process that the CMS server set performs in some embodiments to send out profile update requests for an entity (e.g., company, organization, department, individual, etc.) that uses the CMS server set to capture candidate profiles.

FIG. 11 illustrates a process that the CMS server set performs to process each profile update that it receives from a browser extension.

FIG. 12 conceptually illustrates a computer system with which some embodiments of the invention are implemented.

### DETAILED DESCRIPTION

In the following detailed description of the invention, numerous details, examples, and embodiments of the invention are set forth and described. However, it will be clear and apparent to one skilled in the art that the invention is not limited to the embodiments set forth and that the invention may be practiced without some of the specific details and examples discussed.

Some embodiments of the invention provide novel methods for capturing the profiles of employment candidates. To start the process for capturing such profiles, some embodiments provide a thin browser agent that can be executed within a browser when the browser is displaying an employment candidates profile on a social media webpage. In some embodiments, the browser agent is a bookmarklet (i.e., a bookmark with Javascript code) that can be selected while viewing a candidate's profile on a webpage. In other embodiments, the browser agent is a web browser extension that is installed as a browser plugin. Some embodiments allow a browser to include both a bookmarklet and a browser extension.

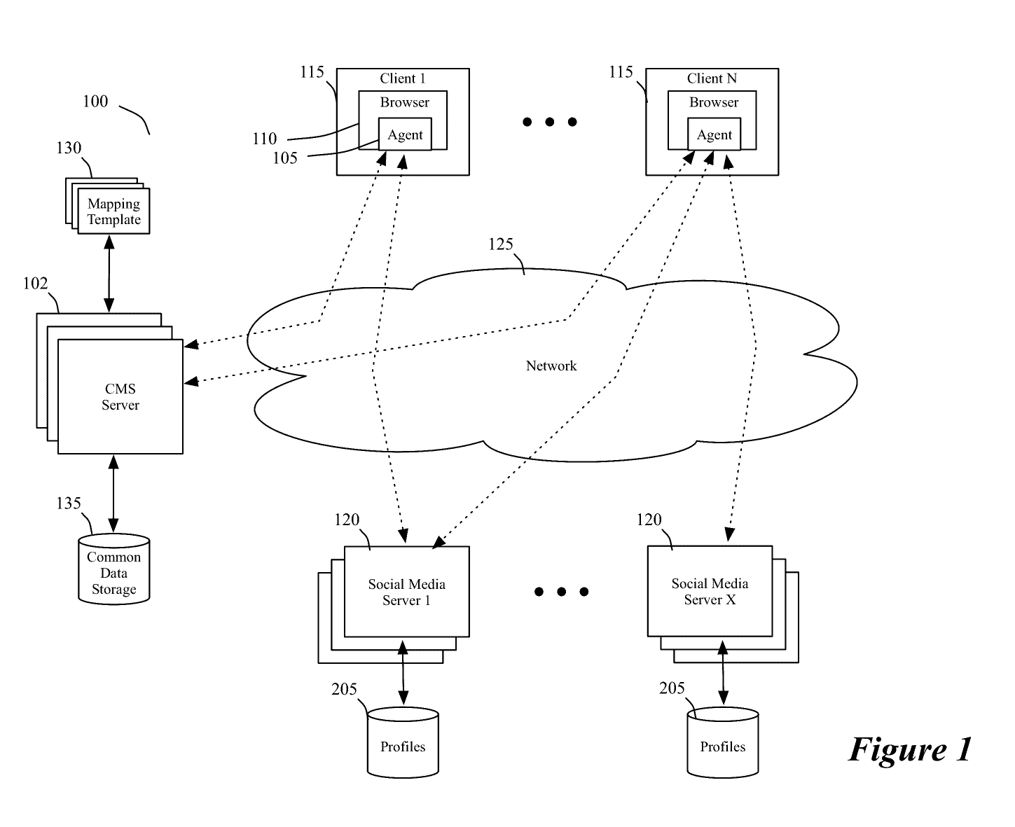

FIG. 1 illustrates a candidate management system (CMS) 100 that uses the thin browser agent method of some embodiments to capture candidate profiles. This figure shows a set of CMS servers 102 that capture candidate profiles by interacting with browser agents 105 that are executed by browsers 110 of client devices 115. The browser agents capture the candidate profiles that are displayed by the browsers. These profiles are the profiles that the browsers of the client devices obtain from the several social media servers 120 of any one of several social media communities (e.g., Linkedin, Facebook, Github, etc.).

As shown, the CMS servers 102, client devices 115, and servers 120 communicate through a network 125 (such a local area network, a wide area network, a network of networks, such as the Internet). As further shown, the CMS server set 102 uses different mapping templates 130 to map profiles from different social media communities to a common data storage 135. In some embodiments, different social media communities store their people profiles in their own profile data storage 140 based on their own specific data structure format. Hence, the CMS server parses and maps the profiles that it receives by using mapping template 130, many of which are custom defined to correctly parse different community's profile webpages and to correctly map the parsed data tuples to the uniform data structure of the common data storage 135, which is used to store the profiles that are captured from the different social media communities in a uniform format.

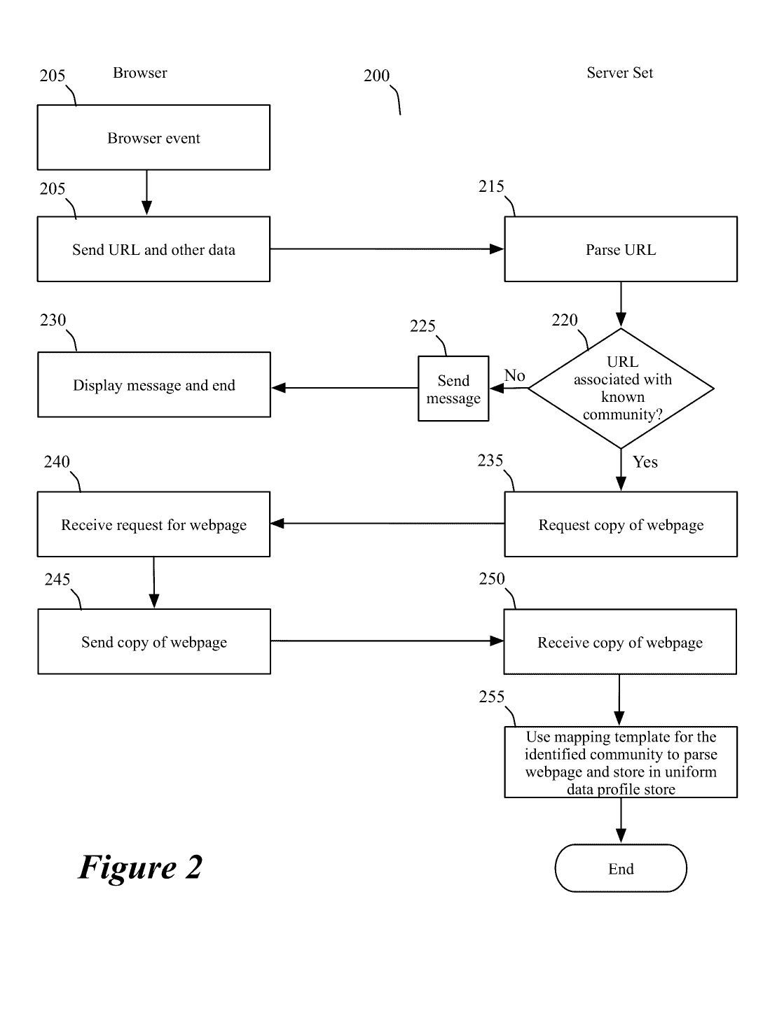

The operation of the browser agents 105 and the CMS server set 102 will now be further described by reference to FIG. 2. This figure illustrates a process 200 that conceptually illustrates various operations that a browser agent 105 and the CMS server set performs after a user performs an operation that the CMS server set interprets as the start of a profile capture process. This operation is shown in FIG. 2 as a browser event operation 205.

When the browser agent is a bookmarklet, the browser event operation 205 on some embodiments is a user's selection of the bookmarklet that appears as a bookmark of the browser. In some embodiments, a bookmarklet is a bookmark that contains Javascript instead of a link. When the bookmarklet is selected, the browser executes the Javascript within the context of the web page, in order to perform one of a wide variety operations with respect to the displayed webpage. In some embodiments, the selection of the bookmarklet causes the browser to contact the CMS server set 102 to initiate the process 200. As further described below, this selection may also cause the CMS server set 102 to provide the browser additional Javascript to execute and/or additional data to process while executing the Javascript.

A browser extension is a plugin (e.g., such a piece of Javascript) that is installed in the browser. It is often more powerful than a bookmarklet as it has access to the browser's APIs. As such, a plugin can perform actions on every page load without user intervention, while a bookmarklet only executes when the user presses the bookmark When the browser agent is a browser extension, the browser event operation 205 in some embodiments is the selection of a profile-posting command that the browser extension displays. In other embodiments, the browser event operation 205 corresponds to a message that the browser extension sends to the CMS server set 102 when the browser first displays a webpage that the browser extension detects as a page from a known social media community.

In still other embodiments, the browser event operation 205 corresponds to a message that the browser extension sends to the CMS server set 102 when the browser first displays any webpage. In other words, in these embodiments, the browser extension generates a message to the CMS server set each time that the browser displays a new webpage without trying to determine whether the webpage is part of a social media community from which candidate profiles can be captured.

In some embodiments, the CMS server set 102 distributes its bookmarklet and browser extensions directly, or indirectly (e.g., through an online application store), before the operation of the process 200. Also, before this operation, the browser extension is installed on the browser of the client computer.

After the browser event operation 205, the browser agent in some embodiments sends (at 210) to the CMS server set the URL (uniform resource locator) of the webpage that the browser is currently displaying. When the browser is displaying multiple webpages, the currently displayed webpage in some embodiments is the webpage that the browser designates as the foreground or active webpage.

Upon receiving the URL, the CMS server set determines whether the URL is part of a set of one or more social media communities from which the server set can capture employment candidate profiles. As shown, the CMS server set makes this determination in some embodiments by parsing (at 215) the URL to extract the portion of the URL that identifies the website domain, and then comparing (at 220) the extracted domain with known social media community domains to determine whether the webpage at issue is part of a known social media community.

When the server set cannot identify (at 220) a social media community for the webpage at issue, the server set in some embodiments returns (at 225) to the browser agent a message to indicate that it cannot capture a profile from this page. The browser agent then displays (at 230) this message and ends the process 200.

On the other hand, when the server set matches (at 220) the URL to a social media community, the server set in some embodiments directs (235) the browser agent to send a copy of the webpage to the server set. The browser agent forwards (240) a snapshot of the webpage (e.g., the downloaded webpage file) to the server set.

After receiving (at 245) the webpage, the server set in some embodiments parses (at 255) the webpage into a plurality of profile data tuples that it then stores in a data storage, which can later be accessed to view the candidate's profile by itself or as part of search queries of the data storage. In some embodiments, the server set stores the profiles that are captured from various different social media communities in the common data storage 135. As mentioned above, different communities typically store the profiles differently.

Because of this, the server set in some embodiments uses different parsing and mapping processes for webpages from different communities. Each of these processes operates based on one of the mapping templates 130. As mentioned above, some or all of these mapping templates are custom defined for the different social media communities in order to ensure that each community's profile webpages is correctly parsed and correctly mapped to the uniform data structure of the common data storage 135 that is used to store the profiles that are captured from the different social media communities. After 255, the process ends.

One of ordinary skill will realize that the process 200 is meant to conceptually illustrate the profile capturing operations of some embodiments of the invention. The specific operations of this process may not be performed in the exact order that is shown in FIG. 2. The specific operations may not be performed in one continuous series of operations, and different specific operations may be performed in different embodiments.

For instance, in some embodiments, the server set might provide data and/or instructions that the browser agent needs to perform its operations before the browser agent is directed to capture a webpage. When the browser agent is a bookmarklet, the server set in some embodiments sends to a browser with a selected bookmarklet (1) additional Javascript code for browser to execute for the bookmarklet and/or (2) data for the browser to process to facilitate the selected bookmarklet operation. As further described below, examples of such data includes data that (1) identifies folders/categories that can be associated to profiles, (2) identifies other CMS users that are related to the user that is viewing the candidate profile, and/or (3) identifies duplicate candidate profiles in the ATS or CRM system (e.g., in the embodiments where the server set matches the URL to a previously captured profile in the profile data storage).

More specifically, as part of the profile capturing process, the browser agent of some embodiments allows the user to specify a particular folder or category of a candidate relationship management (CRM) system or applicant tracking system (ATS) that should be associated with the candidate profile. Both of these systems are implemented by the CMS server set 102 of some embodiments. As described above and further described below, the additional data and/or instructions that the server set provides to the browser agent in some embodiments can include folders and/or categories of the ATS and/or CRM system.

Also, the process 200 shows the server set directing (at 235) the browser agent to send a copy of the webpage to the server set after the server set matches (at 220) the URL to a social media community. In other embodiments, the server set does not immediately ask the browser agent to send a copy of the webpage after matching the URL to a social media community. For instance, even after the server set matches the URL to a social media community, the server set in some embodiments will not request the profile webpage until the user that is viewing the webpage requests the candidate profile to be captured.

However, in some of these embodiments, the server set provides some data to the browser agent after matching the URL to a social community website. For example, in some embodiments, the server set might be able to match the provided URL not only to a social media community but also to a particular profile within that community (e.g., the URL might specify one or more candidate attributes that the server set uses to match the URL to a particular candidate) that the server set has previously captured. To help match the URL to previously captured profiles, the browser agent in some embodiments sends, with the URL, one or more data tuples that it parses from the webpage. In other embodiments, the browser agent does not parse and send any profile data tuples with the URL.

In some of these embodiments, the server set might provide profile data tuples from the previously captured profile to the browser agent after it matches the received URL to a previously captured candidate profile. The browser agent then displays the supplied profile data tuples. If the user then selects the option to capture the profile again at this point, the browser agent in these embodiments sends a copy of the webpage to the server set so that the server set can use this copy to try to refresh the previously captured profile. The refresh process tries to reconcile the two different profile data tuple sets to obtain the best version of truth. The factors that this reconciliation process uses in some embodiment will be further described below.

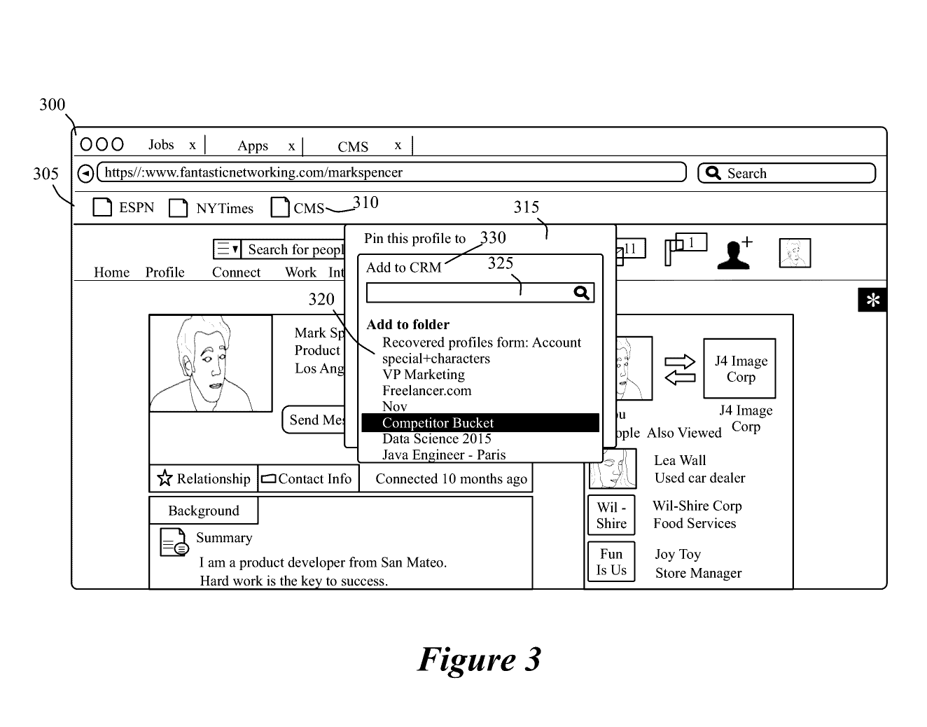

As mentioned above, the browser agent in some embodiments allows the user to specify the folder/category before sending the URL to the server set, and/or after sending the URL to the server set (e.g., after being directed to send a copy of the webpage). FIG. 3 illustrates an example that shows how the bookmarklet of some embodiments allows the user to specify a folder to which a candidate profile is added. This figure illustrates a browser window 300 that displays a candidate's profile on a fictional social media website called FantasticNetworking.com. The candidate's profile includes data about the candidate's contact information, education, job history, connections, etc.

The browser window includes a bookmark bar 305 that includes a bookmarklet 310 for adding candidate profiles to the CMS 100 data store 135. After a user selects this bookmarklet 310, the browser presents a window 315 that gives the user the option of adding the candidate's profile to a folder in a folder list 320 of the CRM system that is maintained by the CMS. This example illustrates the user's selection of Competitor Bucket as the folder to which the candidate's profile should be added. In some embodiments, selection of the control 330 directs the bookmarklet to capture the webpage and send it to the CMS server set. If the user selects the folder, the identity of this folder is sent along as well. In these or other embodiments, selection of the folder directs the bookmarklet to capture the webpage and send it to the CMS server set.

In some embodiments, after the user selects the bookmarklet 310, the browser executes the bookmarklet's Javascript, which causes the browser to contact the CMS server set 102. This server set then provides the browser (1) with additional Javascript to augment the bookmarklet's code and (2) with the folder list 320. In some embodiments, the CMS server set provides the additional Javascript and/or data before the browser provides the URL of the webpage for which the bookmarklet was provided. For instance, in some embodiments, the browser downloads the additional Javascript and data after the bookmarklet is selected, and then provides the URL after the user has selected a CRM folder to which a candidate profile should be added. In other embodiments, the browser first provides the webpage URL, and then downloads the additional Javascript and data to show the window 315.

The window 315 includes a search field 325 that the user can use to search for particular folders in the CRM system. Also, in some embodiments, the window 315 provides a control that allows the user to direct the CMS server set to add a candidate's profile to the ATS of the CMS system. For instance, in some embodiments, when the user selects CRM item 330 in the window 315, a drop down window opens that shows an ATS item (not shown) that the user can select to switch from the CRM system to the ATS. In other embodiments, the selection of the CRM item 330 causes the browser to open the folder list 320. In these embodiments, another control is provided to allow the user to switch between the ATS and CRM systems.

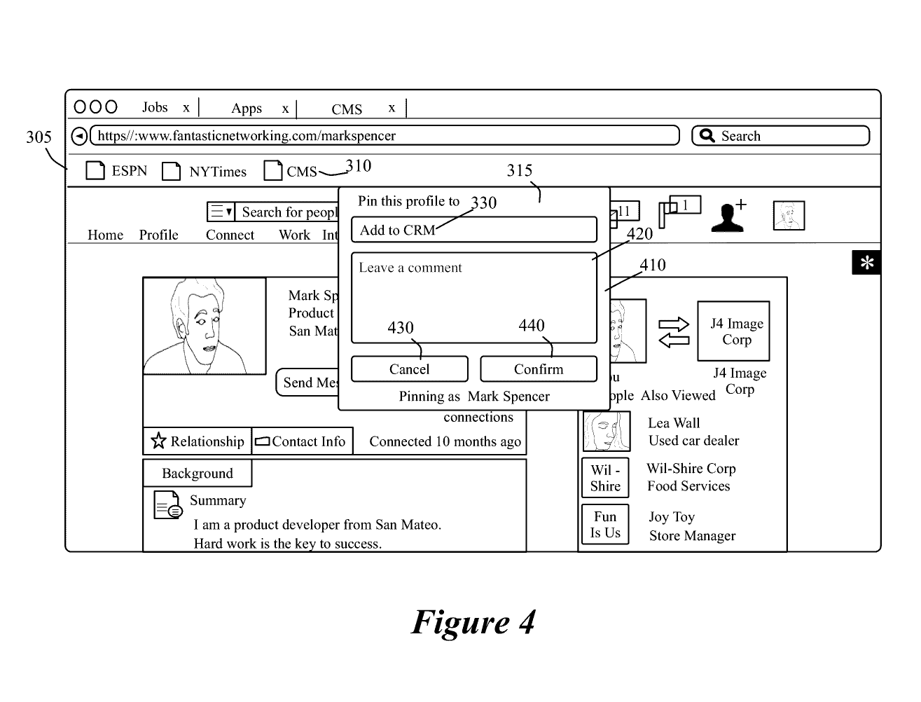

As part of the profile capturing process, the browser agent of some embodiments allows the user to specify comments that should be associated with the candidate profile in the ATS or CRM system. In some embodiments, the browser agent also allows the user to send one or more messages about a captured candidate profile to one or more users of the ATS or CRM system. FIGS. 4-6 illustrate examples of such operations for some embodiments of the invention.

FIG. 4 illustrates the bookmarklet window 315 that the browser shows after the selection of the CMS bookmarklet 310. In this example, this window 315 does not show the list of CRM folders. This might be the case because the user has not yet selected the CRM item 330 to open the folder list.

In FIG. 4, the window 315 includes controls 410 for confirming the handle for storing the candidate's profile. These controls include a user interface (UI) control for specifying a name for associating with the profile. This name (Mark Spencer in this example) is prepopulated by the bookmarklet Javascript code, which extracts the name from the displayed webpage. In other embodiments, the handle is not the candidate's profile but other contact information (e.g., email) of the candidate. In some embodiments, the user can modify the handle. The controls 410 include (1) a Cancel button 430 to cancel the addition of the candidate's profile, and (2) a Confirm button 440 to confirm the addition of the candidate's profile to the CMS data store and/or the addition of the comment to the candidate's profile in the CMS data store.

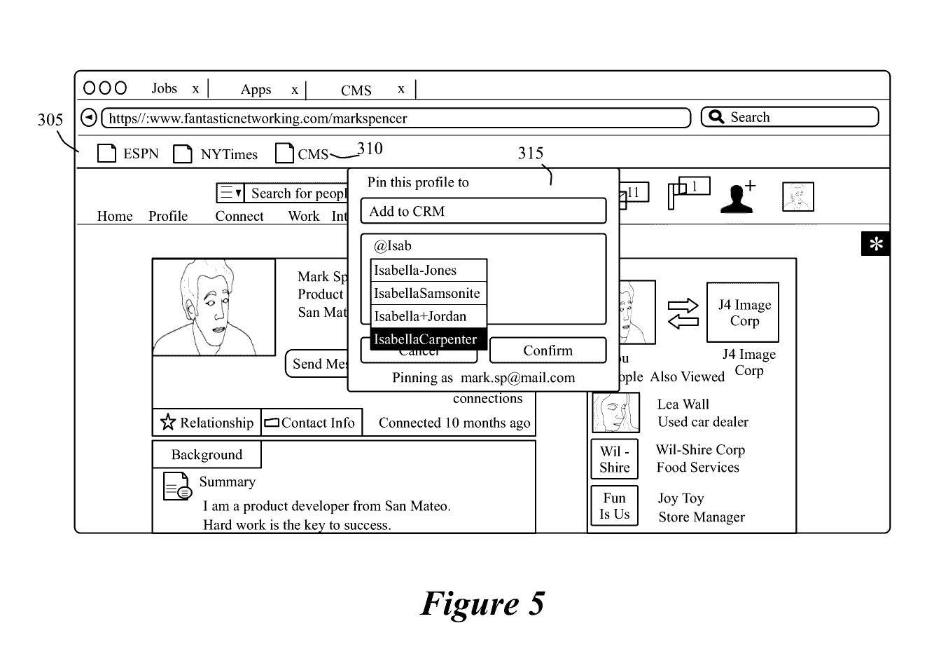

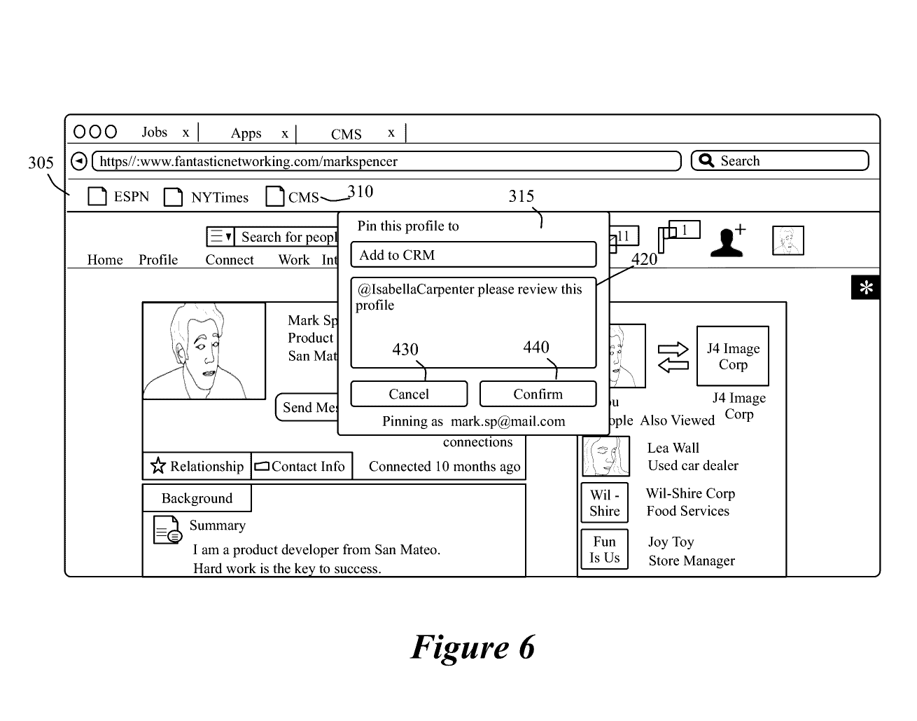

In FIG. 4, the window 315 also includes a comments window 420 in which the user can add comments that are to be associated with the captured candidate profile. In some embodiments, this comments field can also be used to send other users of the CMS messages about a candidate, as shown in FIGS. 5 and 6. FIG. 5 shows a drop down window 505 opening when the user types the handle of another CMS user in the comment field. The drop down window is meant to help the user quickly specify the handle of another user by displaying the list of other users and quickly narrowing this list as the user types more of the handle. This example shows the user selecting (in the drop down window 505) IsabellaCarpenter as the name of the other user after the user has typed in @Isab.

FIG. 6 shows the comments window 420 populated with a comment “@IsabellaCarpenter please review this profile.” Because of the format of this context (because this comment start with an @ followed by a CMS user name), the CMS server set will know that it needs to send an electronic message (e.g., email, SMS, etc.) to Isabella Carpenter after the candidate's profile is captured (e.g., once the user selects the Confirm button 440). In other cases, the comments field might not include a message that requires a message to be sent to anyone else. Also, in other embodiments, the bookmarklet provides one set of controls for recording generic comments regarding a captured candidate profile and another set of controls for sending messages to other users regarding the captured candidate profile.

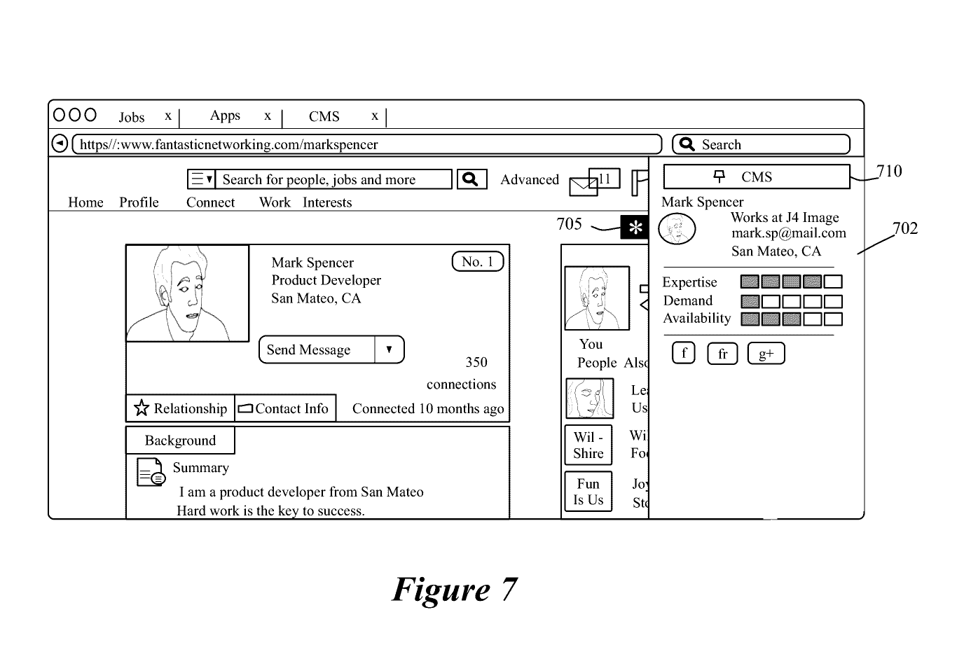

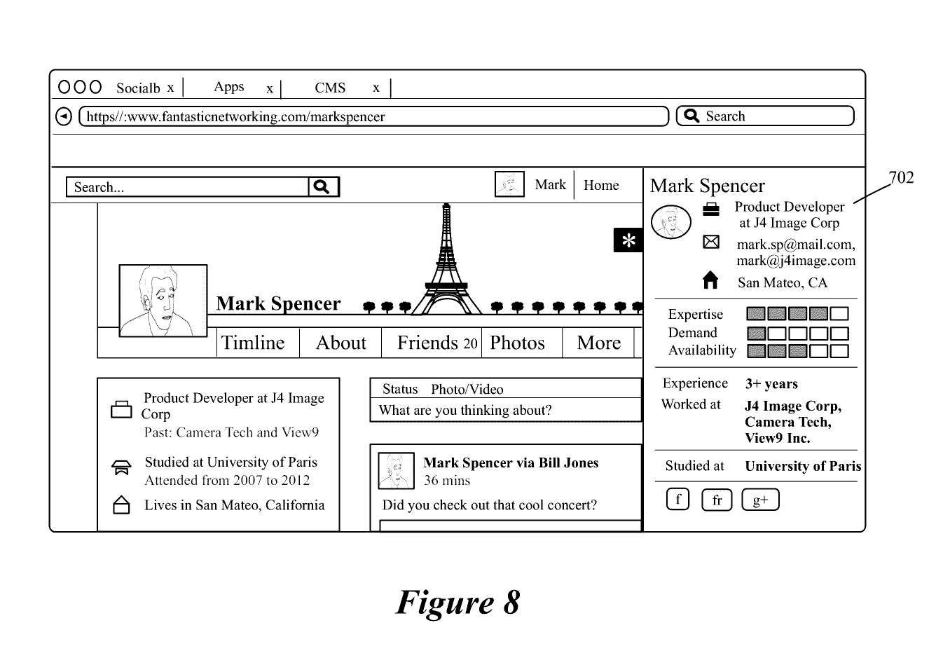

FIGS. 7-8 illustrate examples of the browser extension user interface of some embodiments. Specifically, FIG. 7 illustrates a browser extension window 702 that the browser shows when a user selects a browser extension control 705. In some embodiments, the browser extension control 705 appears on the right side of the browser window 700 when the extension window 702 is not open.

As shown, the extension window 702 displays an initial set of profile data tuples that includes some basic information about the candidate, such as the candidate's name, current job, etc. To extract this information, the browser extension in some embodiments performs an initial parsing operation to parse some data from the candidate profile page. In other embodiments, the browser extension displays this information after the user selects the CMS control 710, which causes the browser to perform the process 100. As mentioned above, the process 100 parses the candidate profile page and supplies candidate profile data tuples to the browser extension when the process recognizes the webpage as belonging to a social media community that it recognizes.

FIG. 8 illustrates the extension window 702 after the CMS server set has matched the candidate's profile to a previously captured profile in its profile data storage 135. In some embodiments, the CMS server set identifies the matching candidate's profile after the user selects the CMS control 710.

In other embodiments, the selection of this control 710 causes the CMS server set to initially parse the candidate webpage and provide parsed profile data tuples to the browser extension. A short time period after providing the parsed profile data tuples to the browser extension, the CMS server set then provides additional information about the candidate if it can match the candidate (i.e., extracted profile data tuples) to a candidate profile that it previously captured and stored in the profile data storage 135. The provided matched profile data presents a more complete picture of the candidate. In some embodiments, the additional matched profile data this is presented includes prior communications (e.g., emails, SMS, etc. that were sent through the CMS system) with the candidate, prior jobs to which the candidate had applies, prior jobs for which the candidate expressed an interest, etc.

Once the candidate profiles are stored in the profile data storage 135, the CMS server set allows users to review these profiles and/or to retrieve these profiles in searches by querying this data storage 125. To provide these profiles, the CMS server set in some embodiments includes a set of webservers that receive search request that provide general search parameters that are to be used to identify any matching candidate profiles. The webserver set in some embodiments can also receive requests for specific candidate profiles and/or request to generally browse the candidate profiles.

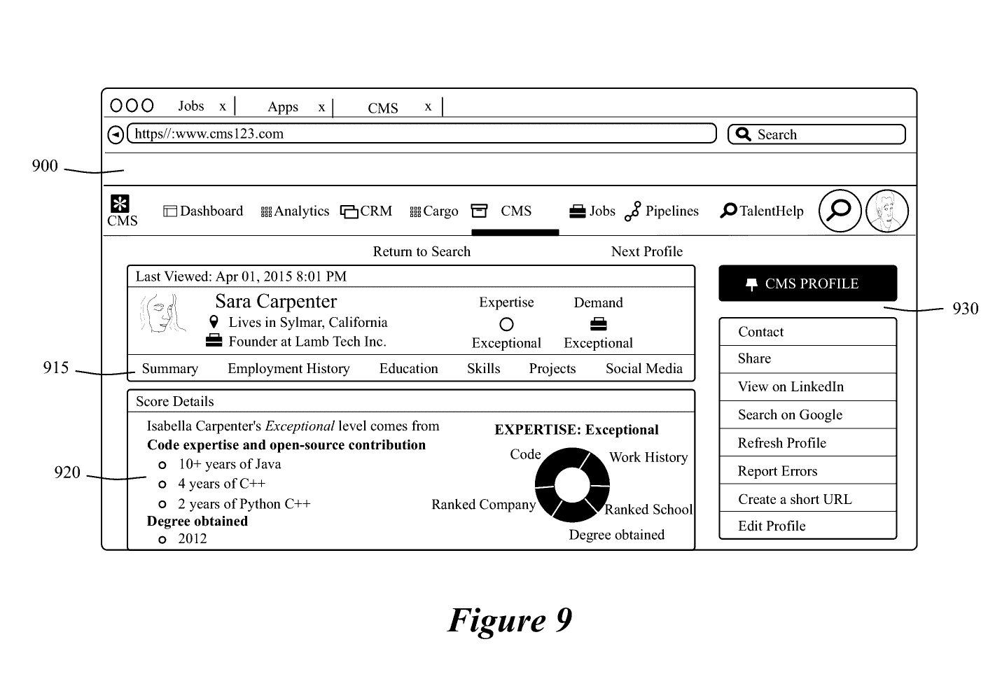

FIG. 9 illustrates an example of a webpage 900 that the CMS webserver of some embodiments provide to present a candidate's profile. The CMS server set 102 aggregates this profile by collecting the candidate's profile from multiple different social media webpages and combining the collected candidate profile into one unified view that provides a 360 view of the candidate. As shown, this view includes various tabs 915 that provide summary information, employment history, education, skills, projects and social media data about the candidate. Selection of any of these tabs directs the CMS webservers to provide (e.g., in a display area in the webpage 900) candidate information that corresponds to the selected tab in a new webpage or in a display area (e.g., in a frame or window) of the webpage 900.

The candidate view in FIG. 9 also includes a scoring window 920 that provides scoring metrics that quantify the candidate's expertise in various areas and lists the criteria used for calculating these scores. In this example, the candidate is ranked Exceptional based on the candidate's coding experience, work history, school rating, degree and rating of past employers. The webpage 900 also provides several controls 930 for the user to perform actions with respect to the profile, such as refreshing the profile, editing the profile, sharing the profile, reporting errors in the profile, etc.

In some embodiments, the CMS server set uses the CMS browser extensions to update candidate profiles. The CMS server set in some embodiments detects that a browser with a CMS browser extension is currently executing on a remote computer. In some embodiments, this browser is the browser of a user that previously captured a set of candidate profiles and stored these profiles in the profile data storage 135 of the CMS system. This browser in some embodiments can also be the browser of any user that is part of a department, an organization, and/or entity for which the set of candidate profiles were collected (e.g., the browser of a user in the same department, organization or entity as the user who captured the set of candidate profiles).

After determining that the browser extension is available (as its browser is open), the CMS server set then requests that the browser extension retrieve copies of a set of one or more webpages that contains a set of one or more candidate profiles that were previously collected. In some embodiments, the set of webpages that the CMS server set provides to the browser extension include at least two webpages regarding the same person on two different social media communities. In some embodiments, this set can include any arbitrary number of webpages regarding the same person from any arbitrary number of social media communities. The CMS server set then uses any webpage that it receives in response to this request to try to update a set of previously collected profiles.

In some embodiments, the browser extension unobtrusively performs its webpage collection in the background so that it does not interfere with the browsing and other operations of the remote computer. To perform its operations unobtrusively in the background, the browser (1) assesses available computational resources of a device on which the browser executes, and (2) when a device has sufficient computational resources, initiates a background data gathering process that does not consume an amount of computation resources that would interfere with other operations currently being performed on the device.

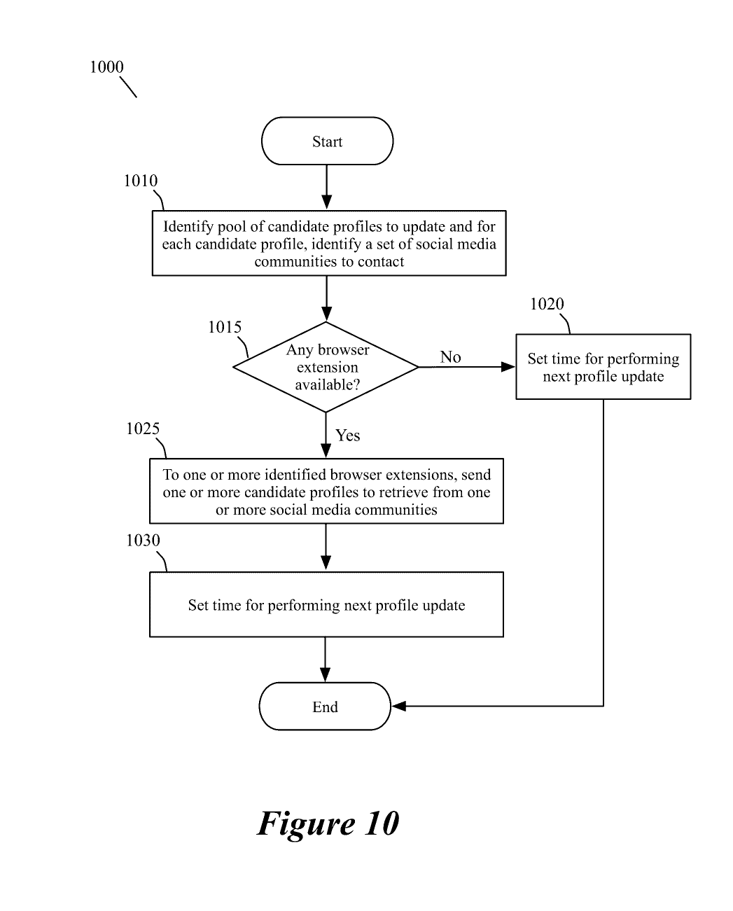

FIG. 10 conceptually illustrates a process 1000 that the CMS server set performs in some embodiments to send out profile update requests for an entity (e.g., company, organization, department, individual, etc.) that uses the CMS server set to capture candidate profiles. The CMS server set concurrently performs similar processes for other entities that use the CMS server set to capture candidate profiles.

To minimize the load, the CMS server set only periodically tries to refresh the collected candidate profiles in some embodiment. Accordingly, the CMS server set performs the process 1000 periodically (e.g., once a day, a week, couple of weeks, a month, a couple of months, etc.) for each entity. As shown, the process 1000 initially identifies (at 1010) a pool of candidate profiles to try to update in its current iteration. In some embodiments, the CMS server set maintains different refresh cycles for different social media communities. For communities that are updated more regularly by their users, the refresh cycles in some embodiments are shorter than the communities that are updated less regularly by their users.

Thus, at 1010, the process 1000 might select some candidate profiles for updating while not selecting other candidate profile. Also, at 1010, the process 1000 might select some social media communities for checking while not selecting other social media communities. Accordingly, at 1010, the process not only identifies candidate profiles to update but also for each candidate profile, identifies one or more social media communities to check.

The process 1000 checks for candidate profile updates by using the CMS browser extensions that operate on remote computers of one or more users of the entity that employs the CMS server set to capture candidate profiles (e.g., the browser of a user who captured the set of candidate profiles, or of a user in the same department, organization or entity as the user who captured the set of candidate profiles). Hence, at 1015, the process determines in some embodiments whether one or more browser extension of the entity are available for contacting the social media communities. For each candidate profile to update, the process 1000 in other embodiments only uses (at 1015) the browser extension of the user that captured the candidate profile.

In some embodiments, each time that a browser with a browser extension is open, the browser extension sends periodic messages to the CMS server set to let the server set know that the extension is available. In other embodiments, the browser extensions do not send such periodic messages. Instead, the CMS server set sends (at 1015) a message (“pings”) each browser extension in order to determine whether the browser extension is available at any given time. In the embodiments that the CMS server set tries to distribute the profile update load across several browser extensions associated with an entity, the CMS server set pings (at 1015) a list of browser extensions that are associated with the entity in order to identify one or more of them that are available at that time.

When the process 1000 determines (at 1015) that no browser extensions are available, it sets (1020) the time for the next profile update for the entity, and then ends. The process sets the time differently in different embodiments. In some embodiments, the process records the time that it attempted to update the profiles, while in other embodiments it records the next time that it should attempt to update the profiles. In yet other embodiments, the process might not expressly have to set the update time at 1020, because the time period for updating the entity's captured profile is explicitly defined through other means.

When process 1000 determines (at 1015) that at least one browser extensions is available (i.e., at least a browser with the needed browser extension is open on a remote computer), the process identifies (at 1025) a set of one or more browser extensions to update one or more candidate profiles from one or more social media communities. In some embodiments, when more than one browser extension is available, the CMS server set uses the browser extension on the remote computer with the least load, or uses multiple browser extensions to distribute the load of the profile update process. Also, to each browser extension that it contacts, the CMS server set sends (1) a set of candidate profiles and (2) for each candidate profile, a set of social media communities from which the candidate's profile webpage should be captured.

After 1025, the process sets (1020) the time for the next profile update for the entity. As mentioned above, this time can be set differently in different embodiments, while in other embodiments, this time does not need to be expressly set as it is implicitly defined. After 1025, the process ends.

A transient time after the process sends out profile update requests at 1025, the CMS server set starts to receive profile updates from the browser extension(s). In some embodiments, a browser extension does not necessarily reply immediately to such an update request because it has to schedule each profile capture update operation to occur as a background process that operates unobtrusively on its machine without interfering with other processes that operate on the foreground on the machine.

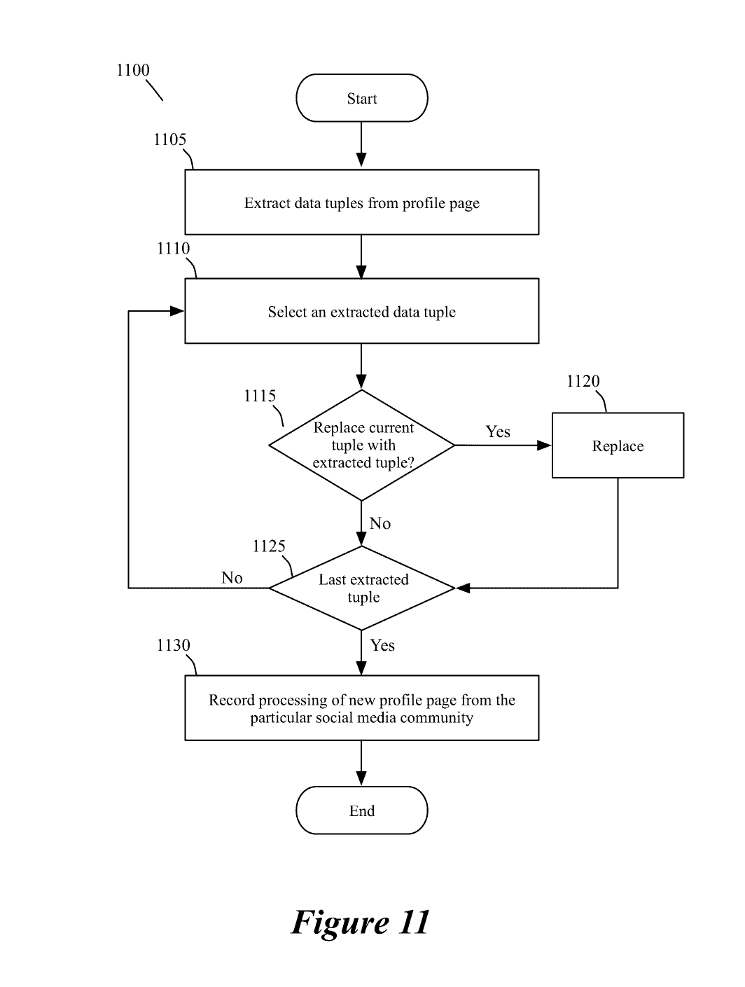

FIG. 11 illustrates a process 1100 that the CMS server set performs to process each profile update that it receives from a browser extension. The profile update operations of the process 1100 are also used by the CMS server set in some embodiments to update a profile captured through a bookmarklet. In some embodiments, each profile update that the process 1100 receives is a copy of a profile page for a particular candidate from a particular social media community. In its attempt to update previously collected profiles, the process 1100 in some embodiments initially performs a parsing operation (at 1105) to extract a plurality of data tuples from each candidate profile page that it receives.

The process then selects (at 1110) one of the extracted data tuples, and compares (at 1115) the selected data tuple with a corresponding data tuple in the previously stored candidate profile to determine whether the newly extracted data tuple should replace the corresponding data tuple in the profile. In some embodiments, the determination of whether the extracted data tuple should replace the previously stored data tuple involves using a set of criteria to designate one of the two data tuples as a best version of truth. The set of criteria in some embodiments includes one or more of the following criteria: (1) a reputation value associated with each source of each data tuple, (2) a time value associated with when each data tuple was obtained, and (3) a relevancy value that quantifies the relevancy of the source of the data tuple with the data tuple's type. Other embodiments use other types of criteria to assess the best version of truth.

In some embodiments, for each of two different data tuples that are candidate values for the same candidate profile parameter, the process computes a score based on the above-mentioned criteria (i.e., reputation, time value, relevancy). In these embodiments, the process then selects the data tuple with the best score. In some embodiments, each score is computed as a weighted sum that combines various sub-scores of the data tuple for the various criteria, into one aggregate score that can be used to compare against another aggregate score. The weighted sum multiplies each sub-score of the data tuple with a weight value. The different weight value of each criterion express the relative importance of the criterion as compared to the other criteria.

When the process determines (at 1115) that the selected, extracted tuple should be used, it replaces (at 1120) the current tuple with the extracted tuple and then transitions to 1125. On the other hand, when the process determines (at 1115) that the selected, extracted tuple should not replace the current tuple in the profile, the process simply transitions to 1125. At 1125, the process determines whether it has examined all data tuples extracted at 1105. If not, the process returns to 1110 to select another extracted data tuple to process.

When the process determines (at 1125) that it has processed all extracted data tuples, it records (at 1130) that the time that it has processed a new profile page for the particular candidate from the particular social media community. This recording allows the CMS server set to determine the next time by which it should try to update the particular candidate profile by downloading a new page from the particular social media community. After 1130, the process ends.

To ensure that the CMS server set gets a new profile page for each profile update request that it sends to a browser extension, the CMS server set in some embodiments performs a monitoring process to keep track of prior profile requests for which it has not received any response. In other embodiments, the CMS server set does not perform such a monitoring process. Instead, it relies on this deficiency being rectified implicitly by later profile update requests that the CMS server set will inevitably send out because the candidate profiles will not be marked as being updated by new pages that satisfied previous profile update requests.

One of ordinary skill will realize that the processes 1000 and 1100 are simply conceptually illustrations of some of the operations performed by the CMS server set in some embodiments. The specific operations may not be performed in the exact order that is shown in FIGS. 10 and 11. The specific operations may not be performed in one continuous series of operations, and different specific operations may be performed in different embodiments.

For instance, in some embodiments, the CMS server set performs its profile update process only from the pool of available browser extensions. In other words, in these embodiments, the CMS server set first identifies the group of browser extensions that are currently available, and then determines whether for that browser extension group there are any associated candidate profiles that need to be updated at that time. Also, in some embodiments, the CMS server set does not perform its profile request process 1000 on an entity-by-entity basis. Instead, it might perform this update on a profile-by-profile basis or community-by-community basis.

Many of the above-described features and applications are implemented as software processes that are specified as a set of instructions recorded on a computer readable storage medium (also referred to as computer readable medium). When these instructions are executed by one or more processing unit(s) (e.g., one or more processors, cores of processors, or other processing units), they cause the processing unit(s) to perform the actions indicated in the instructions. Examples of computer readable media include, but are not limited to, CD-ROMs, flash drives, RAM chips, hard drives, EPROMs, etc. The computer readable media does not include carrier waves and electronic signals passing wirelessly or over wired connections.

In this specification, the term “software” is meant to include firmware residing in read-only memory or applications stored in magnetic storage, which can be read into memory for processing by a processor. Also, in some embodiments, multiple software inventions can be implemented as sub-parts of a larger program while remaining distinct software inventions. In some embodiments, multiple software inventions can also be implemented as separate programs. Finally, any combination of separate programs that together implement a software invention described here is within the scope of the invention. In some embodiments, the software programs, when installed to operate on one or more electronic systems, define one or more specific machine implementations that execute and perform the operations of the software programs.

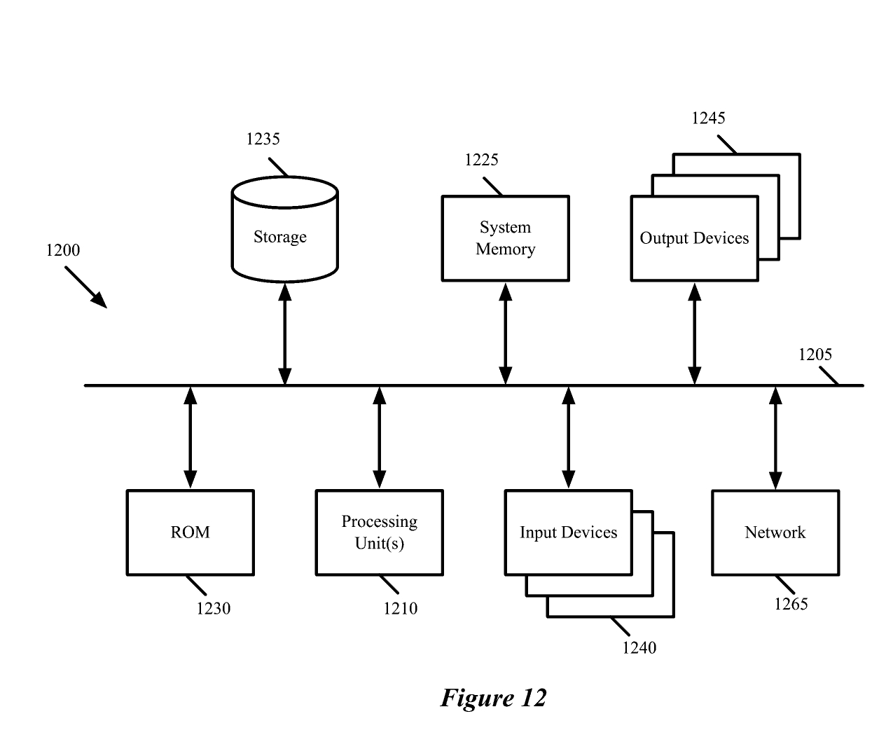

FIG. 12 conceptually illustrates a computer system 1200 with which some embodiments of the invention are implemented. The computer system 1200 can be used to implement any of the above-described hosts, controllers, and managers. As such, it can be used to execute any of the above described processes. This computer system includes various types of non-transitory machine readable media and interfaces for various other types of machine readable media. Computer system 1200 includes a bus 1205, processing unit(s) 1210, a system memory 1225, a read-only memory 1230, a permanent storage device 1235, input devices 1240, and output devices 1245.

The bus 1205 collectively represents all system, peripheral, and chipset buses that communicatively connect the numerous internal devices of the computer system 1200. For instance, the bus 1205 communicatively connects the processing unit(s) 1210 with the read-only memory 1230, the system memory 1225, and the permanent storage device 1235.

From these various memory units, the processing unit(s) 1210 retrieve instructions to execute and data to process in order to execute the processes of the invention. The processing unit(s) may be a single processor or a multi-core processor in different embodiments. The read-only-memory (ROM) 1230 stores static data and instructions that are needed by the processing unit(s) 1210 and other modules of the computer system. The permanent storage device 1235, on the other hand, is a read-and-write memory device. This device is a non-volatile memory unit that stores instructions and data even when the computer system 1200 is off. Some embodiments of the invention use a mass-storage device (such as a magnetic or optical disk and its corresponding disk drive) as the permanent storage device 1235.

Other embodiments use a removable storage device (such as a floppy disk, flash drive, etc.) as the permanent storage device. Like the permanent storage device 1235, the system memory 1225 is a read-and-write memory device. However, unlike storage device 1235, the system memory is a volatile read-and-write memory, such a random access memory. The system memory stores some of the instructions and data that the processor needs at runtime. In some embodiments, the invention's processes are stored in the system memory 1225, the permanent storage device 1235, and/or the read-only memory 1230. From these various memory units, the processing unit(s) 1210 retrieve instructions to execute and data to process in order to execute the processes of some embodiments.

The bus 1205 also connects to the input and output devices 1240 and 1245. The input devices enable the user to communicate information and select commands to the computer system. The input devices 1240 include alphanumeric keyboards and pointing devices (also called “cursor control devices”). The output devices 1245 display images generated by the computer system. The output devices include printers and display devices, such as cathode ray tubes (CRT) or liquid crystal displays (LCD). Some embodiments include devices such as a touchscreen that function as both input and output devices.

Finally, as shown in FIG. 12, bus 1205 also couples computer system 1200 to a network 1265 through a network adapter (not shown). In this manner, the computer can be a part of a network of computers (such as a local area network (“LAN”), a wide area network (“WAN”), or an Intranet, or a network of networks, such as the Internet. Any or all components of computer system 1200 may be used in conjunction with the invention.

Some embodiments include electronic components, such as microprocessors, storage and memory that store computer program instructions in a machine-readable or computer-readable medium (alternatively referred to as computer-readable storage media, machine-readable media, or machine-readable storage media). Some examples of such computer-readable media include RAM, ROM, read-only compact discs (CD-ROM), recordable compact discs (CD-R), rewritable compact discs (CD-RW), read-only digital versatile discs (e.g., DVD-ROM, dual-layer DVD-ROM), a variety of recordable/rewritable DVDs (e.g., DVD-RAM, DVD-RW, DVD+RW, etc.), flash memory (e.g., SD cards, mini-SD cards, micro-SD cards, etc.), magnetic and/or solid state hard drives, read-only and recordable Blu-Ray® discs, ultra density optical discs, any other optical or magnetic media, and floppy disks. The computer-readable media may store a computer program that is executable by at least one processing unit and includes sets of instructions for performing various operations. Examples of computer programs or computer code include machine code, such as is produced by a compiler, and files including higher-level code that are executed by a computer, an electronic component, or a microprocessor using an interpreter.

While the above discussion primarily refers to microprocessor or multi-core processors that execute software, some embodiments are performed by one or more integrated circuits, such as application specific integrated circuits (ASICs) or field programmable gate arrays (FPGAs). In some embodiments, such integrated circuits execute instructions that are stored on the circuit itself.

As used in this specification, the terms “computer”, “server”, “processor”, and “memory” all refer to electronic or other technological devices. These terms exclude people or groups of people. For the purposes of the specification, the terms display or displaying means displaying on an electronic device. As used in this specification, the terms “computer readable medium,” “computer readable media,” and “machine readable medium” are entirely restricted to tangible, physical objects that store information in a form that is readable by a computer. These terms exclude any wireless signals, wired download signals, and any other ephemeral or transitory signals.

While the invention has been described with reference to numerous specific details, one of ordinary skill in the art will recognize that the invention can be embodied in other specific forms without departing from the spirit of the invention. For instance, while the refresh processes 1000 and 1100 are described above by reference to examples related to candidate profile updates, one of ordinary skill will realize that these processes are used in some embodiments to refresh other types of data that are captured online. In other words, the methodology of some embodiments that refreshes online captured data by using browser extensions of browsers on remote computers to retrieve web content from other computers and provide them to a server set that aggregates and/or reconciles this content, is used in other embodiments to refresh other type of online captured content (such as posted photos, messages, tweets, etc.). Thus, one of ordinary skill in the art would understand that the invention is not to be limited by the foregoing illustrative details, but rather is to be defined by the appended claims.

1. A method of maintaining profiles comprising:
detecting that a browser that is associated with a previously collected profile of a person is executing on a remote computer;
directing a browser extension on the browser to retrieve data associated with a webpage that contains the person's profile;
receiving the webpage data; and
using the received webpage data to update the previously collected profile of the person.

2. The method of claim 1, wherein the browser is a browser that was used previously to collect the person's profile.

3. The method of claim 1, wherein the browser is a browser that executes on a computing device of a person or entity that previously collected the profile.

4. The method of claim 1, wherein the browser is a browser of a person or entity for which the profile was previously collected.

5. The method of claim 1, wherein receiving webpage data comprises receiving the webpage, the method further comprising
extracting a plurality of data tuples from the webpage relating to the person's profile; and
comparing each extracted data tuple with a corresponding data tuple in the previously collected profile to determine whether the extracted data tuple should replace in the person's profile the corresponding data tuple that was previously stored in the collected profile.

6. The method of claim 5, wherein determining whether the extracted data tuple should replace the previously stored corresponding data tuple comprises using a set of criteria to designate one of the two data tuples as a best version of truth.

7. The method of claim 6, wherein the set of criteria comprises at least one of:
a reputation value associated with the source of the data tuple;
a time value associated with when the data tuple was obtained; and
a relevancy value that quantifies the relevancy of the source of the data tuple with the data tuple's type.

8. The method of claim 1, wherein directing the browser extension comprises providing the browser extension with a set of webpage to access to retrieve data associated with a set of people, wherein the set of webpages includes at least two webpages associated with one person in the set of people.

9. The method of claim 1, wherein the browser extension (i) assesses available computational resources of a device on which the browser executes, and (ii) when a device has sufficient computational resources, initiates a background data gathering process that does not consume an amount of computation resources that would interfere with other operations currently being performed on the device.

10. The method of claim 9, wherein the browser extension assesses the available computation resources after receiving the direction to retrieve the data.

11. The method of claim 1 further comprising determining whether a time period has been reached to try to update the person's profile.

12. The method of claim 11, wherein the time period is a periodically repeating time period.

13. The method of claim 11, wherein the determination regarding the time period occurs before detecting that the browser is executing on the computer.

14. The method of claim 11, wherein the determination regarding the time period occurs after detecting that the browser is executing on the computer.

15. The method of claim 11 further comprising scheduling the updating of the person's profile along with the updating a plurality of other people's profiles.

16. A non-transitory machine readable medium storing a program for maintaining profiles, the program comprising sets of instructions for:
detecting that a browser that is associated with a previously collected profile of a person is executing on a remote computer;
directing a browser extension on the browser to retrieve data associated with a webpage that contains the person's profile;
receiving the webpage data; and
using the received webpage data to update the previously collected profile of the person.

17. The non-transitory machine readable medium of claim 16, wherein the set of instructions for receiving webpage data comprises a set of instructions for receiving the webpage, the program further comprising sets of instructions for:
extracting a plurality of data tuples from the webpage relating to the person's profile; and
comparing each extracted data tuple with a corresponding data tuple in the previously collected profile to determine whether the extracted data tuple should replace in the person's profile the corresponding data tuple that was previously stored in the collected profile.

18. The non-transitory machine readable medium of claim 17, wherein the set of instructions for determining whether the extracted data tuple should replace the previously stored corresponding data tuple comprises a set of instructions for using a set of criteria to designate one of the two data tuples as a best version of truth.

19. The non-transitory machine readable medium of claim 18, wherein the set of criteria comprises at least one of:
a reputation value associated with the source of the data tuple;
a time value associated with when the data tuple was obtained; and
a relevancy value that quantifies the relevancy of the source of the data tuple with the data tuple's type.

20. The non-transitory machine readable medium of claim 16, wherein the set of instructions for directing the browser extension comprises a set of instructions for providing the browser extension with a set of webpage to access to retrieve data associated with a set of people, wherein the set of webpages includes at least two webpages associated with one person in the set of people.

21. The non-transitory machine readable medium of claim 16, wherein the browser extension (i) assesses available computational resources of a device on which the browser executes, and (ii) when a device has sufficient computational resources, initiates a background data gathering process that does not consume an amount of computation resources that would interfere with other operations currently being performed on the device.
